(19) United States
(12) Patent Application Publication
(10) Pub. No.: US 2011/0136972 A1
(43) Pub. Date: Jun. 9, 2011

(54) THERMAL CURABLE POWDER COATING COMPOSITION

(75) Inventors: Carmen Flosbach, Wuppertal (DE); Engin Temeltas, Wuppertal (DE); Kristina Iland, Koeln (DE)

(73) Assignee: E.I. DU PONT DE NEMOURS AND COMPANY

(21) Appl. No.: 13/058,916

(22) PCT Filed: Sep. 3, 2009
(86) PCT No.: PCT/US09/55883

§ 371 Date: Feb. 14, 2011

(30) Foreign Application Priority Data
Sep. 4, 2008 (US) 61190938

(51) Int. Cl. C09D 175/00; B05D 3/00

(52) U.S. Cl. 524/590; 427/385.5

(57) ABSTRACT

The present invention provides a powder coating composition comprising at least one hydroxyl functional polyuretdione resin binder, wherein the at least one hydroxyl functional polyuretdione resin binder having a melting temperature of 60 to 180° C., in particular, 80 to 160° C. The powder coating composition according to the invention comprising the specific kind of the polyuretdione resin binder makes it possible to provide desired technological properties, in particular, thin films and high flexibility in combination with an excellent weather resistance of the coating layers.

### FIELD OF THE INVENTION

The present invention is directed to a powder coating composition based on specific polyuretdione resins providing high flexibility in combination with excellent weather resistance of the coating layers and high processability of the powder coating compositions.

### DESCRIPTION OF PRIOR ART

Epoxy, polyester and acrylic resin binders are well-known for the use in thermal curable powder coating compositions. For example, hydroxyl functional polyesters are curable with isocyanates to result in polyurethane powder coatings, see D. Bates, The Science of Powder Coatings, Volume 1, London, 1990, pages 56, 276-277, 282.

Combinations of different resin binders and curing agents are investigated to receive specific desired properties of the coatings on different substrate surfaces.

EP-A 1209182, EP-A 1323757 and WO 02/50147 refer to coating compositions based on specific urethane acrylates or a mixture of different polymers, for example, different urethane acrylates, wherein the compositions are cured by ultra violet (UV) radiation to provide coatings with good mechanical properties and flexibility.

Thermal curable powder coating compositions based on urethane (meth) acrylates or specific polyester urethanes are disclosed in WO 01/25306, EP-A 702040, EP-A 410242 and WO 95/35332 and refer to good storage stability and increased weather resistance of the coatings.

Uretdione based powder resins are used as curing agent (hardener) for hydroxyl-functional polyester coating systems. Such uretdione based resins are amorphous, and they are produced from isophorone diisocyanate. In the U.S. Pat. No. 5,795,950, crystalline polyuretdiones are disclosed used as hardener in powder coating compositions.

While current state of the art discloses powder coating compositions having good technology properties, they do not offer in particular the level of high flexibility in combination with a potential of building of thin films. Accordingly, there is a need for powder coating compositions, and methods of application thereof, that meet those requirements.

### SUMMARY OF THE INVENTION

The present invention provides a powder coating composition comprising at least one hydroxyl functional polyuretdione resin binder, wherein the at least one hydroxyl functional polyuretdione resin binder having a melting temperature of 60 to 180° C., in particular, 80 to 160° C.

The powder coating composition according to the invention comprising the specific kind of the polyuretdione resin binder makes it possible to provide desired technological properties, in particular, low curing temperatures, thin films and high flexibility in combination with an excellent weather resistance of the coating layers. The hydroxyl functional polyuretdione resin binder of the invention can be used as self-curing binder resin. Additionally, the powder coating composition according to the invention comprising the hydroxyl functional polyuretdione resin binder of the invention makes it possible to cure the resulting coatings without release of any blocking agents usually used in the isocyanate chemistry.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

Slight variations above and below the stated ranges of numerical values can be used to achieve substantially the same results as values within the ranges. Also, the disclosure of these ranges is intended as a continuous range including every value between the minimum and maximum values.

Particularly the present invention refers to a powder coating composition comprising 25 to 99 weight percent (wt %), preferably 40 to 95 wt %, of the at least one hydroxyl functional polyuretdione resin binder, the wt % being based on the total weight of the powder coating composition.

The at least one hydroxyl functional polyuretdione resin binder of the invention has a melting temperature of 60 to 180° C., in particular 80 to 160° C. The melting temperatures are not in general sharp melting points, but instead the upper end of melting ranges with a breadth of, for example, 30 to 150° C., depending from the kind of the resin binder.

The melting ranges and thus the melting temperatures may be determined, for example, by DSC (differential scanning calorimetry) at heating rates of 10 K/min, determined according to DIN 53765-B-10.

The term “upper end of melting ranges” used in this description has the meaning of the range of T_{SE} determined according to DIN 53765-B-10.

The at least one hydroxyl functional polyuretdione resin binder is very slightly, if at all, soluble in organic solvents conventional used in coatings and/or in water, the solubility amounting, for example, to less than 10, in particular less than 5 g per litre of butyl acetate or water at 20° C.

All the number-average molar mass data stated in the present description are number-average molar masses determined or to be determined by gel permeation chromatography (GPC; divinylbenzene-cross-linked polystyrene as the immobile phase, tetrahydrofuran as the liquid phase, polystyrene standards), determined according to ISO 13885-1 standard.

The polyuretdione resin binders of the invention are hydroxyl functional resins and have hydroxyl values of, for example, 20 to 300 mg KOH/g.

The hydroxyl value is defined as the number of mg of potassium hydroxide (KOH) which is equal to the number of mg acetic acid for acetalizing of 1 g of the resin, determined according to DIN 53240.

The hydroxyl functional polyuretdione resin may be produced in general by reacting isocyanate (NCO) functional uretdione(s) with alcohols in such a way that the ratio of free NCO groups to hydroxyl groups is in a range of 0.5:1 to 0.5:3, preferably 0.5:1 to 0.5:2.

Suitable NCO functional uretdiones are prepared by methods of dimerization of polyisocyanates, known to a person skilled in the art, for example, by reacting polyisocyanates in non-reacting solvents in the presence of reaction catalysts, at temperatures in the range of, for example, 0 to 130° C., see, for example, H. J. Laas, R. Halpaap, J. Pedain, “Zur Synthese aliphatischer Polyisocyanate—Lackpolyisocyanate mit Biuret-, Isocyanurat-oder Urtdionstruktur”, J. Prakt. Chemie 336, (1994) 185.

Examples of NCO functional uretdiones are uretdiones based on hexamethylene diisocyanate (HDI), 1,4-cyclohexandiisocyanate, biscyclohexylmethandiisocyanate, trimetyhlhexyldiisocyanate, isophorone diisocyanate (IPDI), uretdiones based on aromatic structures known to those skilled in the art like diphenylmethandiisocyanate (MDI). The uretdiones can contain other structures like isocyanurate structures besides the uretdione structure. Preferred are uretdiones based on aliphatic diisocyanates.

The alcohols can be linear and/or branched alcohols. Diols and polyols, such as triols, are particularly suitable, on its own, or in mixture.

Diol(s) and polyols suitable for the production of the polyuretdione resins are not only diols and polyols in the form of low molar mass compounds defined by empirical and structural formula but also oligomeric or polymeric diols or polyols with number-average molar masses of, for example, up to 800, for example, corresponding hydroxyl-functional polyethers, polyesters or polycarbonates. Low molar mass polyols defined by an empirical and structural formula are, however, preferred.

The person skilled in the art selects the nature and proportion of the isocyanate (NCO) functional uretdione(s) and alcohols in such a manner that hydroxyl functional polyuretdione resins of the invention with the above-mentioned melting temperatures are obtained.

Mono alcohols can be used particularly as chain stopper to terminate the polymer chain. Examples of mono alcohols are ethanol, propanol, butanol, pentanol, hexanol, dekanol.

Examples of linear and branched diols are ethylenglycol, isomeric propandiols and butandiols, 1,2-propandiol, 1,3-propandiol, 1,3-butandiol, 1,4-butandiol, 1,4-pentandiol, 1,5-pentandiol, 1,2-hexandiol, 1,5-hexandiol, 2,5-hexandiol, 1,6-hexandiol, 1,10-dekandiol, 1,12-dodekandiol, neopentylglykol, also (cyclo)aliphatic, aromatic or araliphatic diols with a molar mass in the range of, for example, 62 to 600 such as 1,4-cyclohexanedimethanol, hydrogenated bisphenol A, dimer fatty alcohol, telechelic (meth)acrylic polymer diols, polyester diols, polyether diols, polycarbonate diols, each with a number-average molar mass of, for example, up to 800, butylethylpropanediol, the isomeric cyclohexanediols, the isomeric cyclohexanedimethanols, tricyclodecanedimethanol, pentaerythritol. Preferred is the use of linear diols.

The term “(cyclo) aliphatic” used in this description and the claims encompasses cycloaliphatic, linear aliphatic, branched aliphatic and cycloaliphatic with aliphatic residues. The aromatic or araliphatic diols comprise diols with aromatically and/or aliphatically attached hydroxyl groups.

Examples of polyols are glycerol, trimethylolethane, trimethylolpropane or pentaerythritol.

Additionally, monomers of isocyanates can be used for the preparation of the hydroxyl functional polyuretdione resins of the invention. Examples of such isocyanates are diisocyanates, for example, HDI, IPDI, hydrogenated MDI. For such cases, the hydroxyl functional polyuretdione resin binders may be produced by reacting the monomers of isocyanates with the alcohol(s) in such a way that the content of free NCO groups to the content of hydroxyl groups is in a range of 0.5:1 to 0.5:2, preferably 0.5:1 to 0.5:1.5.

The reaction conditions are selected in such a way that the ring opening of the uretdione ring can be avoided, that means, at reaction temperatures in the range of, for example, 60 to 140° C.

The preparation of the hydroxyl functional polyuretdione resin binders of the invention may be done in apparatus known for the preparation of polyurethanes, in general, as known to a person skilled in the art.

The hydroxyl functional polyuretdione resin binders of the invention may have a number-average molar mass in a range of 1000 to 10000, preferred 1000 to 5000.

The resulted polyuretdione resins of the invention do not require working up and may be used directly as hydroxyl functional polyuretdione resin binder of the invention.

The hydroxyl functional polyuretdione resin binder of the invention can be used as self-curing binder resin in the powder coating composition according to the invention. This means, that it can be used without any use of further binder resins and curing agents usually used in powder coating compositions and as known to a person skilled in the art.

Additionally, the powder coating composition according to the invention comprising the hydroxyl functional polyuretdione resin binder of the invention makes it possible to cure the resulting coatings without release of any blocking agents usually used in the isocyanate chemistry.

The hydroxyl functional polyuretdione resin binder of the invention can also be used as co-binder resin in the powder coating composition according to the invention together with further binder resins and optionally their curing agents usually used in powder coating compositions and as known to a person skilled in the art. Such further binder resins and curing agents may be crystalline, semi-crystalline and/or amorphous compounds. Examples for these different curing mechanisms are systems based on epoxy/acid addition, hydroxyl/blocked polyisocyanate, hydroxyl/esterification, UV-curing as known to those skilled in the art. Examples of such binder resins are polyester, polyurethane and (meth)acrylic copolymer resins and hybrid binders derived from these classes of binders, for example, with hydroxyl values of, for example, 60 to 300 mg of KOH/g and number-average molar masses of, for example, 500 to 10000. Examples of curing agents for these further resin binders are, for example, Vestagon BF 1540, Crelan® EF 403, Crelan® LP LAS 3969.

The coating composition according to the invention may contain the further binder resins and their curing agents in amounts in a range up to 75 wt %, optionally, in a range of 1 to 75 wt %, the wt % being based on the total weight of the powder coating composition.

The coating compositions of the present invention may further comprise one or more pigments, fillers and/or coating additives.

Additives are selected from the group consisting of flow control agents, dispersants, thixotropic agents, adhesion promoters, antioxidants, light stabilizers, anticorrosion agents, inhibitors, catalysts, levelling agents, wetting agents, anticratering agents, and mixtures thereof. Catalysts, suitable for the self-curing hydroxyl functional polyuretdione resin binder can be used, for example, zinc hexadecanoat, tin hexadecanoat, zinc acetylacetonate, or zinc acetate. The additives are used in conventional amounts known to the person skilled in the art, for example, 0.1 to 10 wt %, based on the total wt % of the coating composition.

In case of dual cure coating compositions, usually used photoinitiators known to a person skilled in the art are contained therein.

The coating compositions may also contain transparent pigments, color-imparting and/or special effect-imparting pigments and/or fillers, in amounts of, for example, 5 to 60 wt %, preferred 5 to 40 wt %, based on the total wt % of the coating composition. Suitable color-imparting pigments are any conventional coating pigments of an organic or inorganic nature. Examples of inorganic or organic color-imparting pigments are titanium dioxide, iron oxide pigments, carbon black, azo pigments, phthalocyanine pigments, quinacridone pigments and pyrrolopyrrole pigments. Examples of special effect pigments are metal pigments, for example, of aluminum, copper or other metals, interference pigments, such as, for example, metal oxide-coated metal pigments, for example, iron oxide-coated aluminum, coated mica, such as, for example, titanium dioxide-coated mica, graphite effect-imparting pigments, iron oxide in flake form, liquid crystal pigments, coated aluminum oxide pigments, coated silicon dioxide pigments. Examples of fillers are silicon dioxide, aluminum silicate, barium sulfate, calcium carbonate and talc.

Under heat the powder coating composition according to the invention show a steep decrease in viscosity in the melting range of its components. The viscosity of the powder coating composition just slightly decreases further by increasing the temperature. The melt viscosity of the powder coating composition of the invention is very low. Measured with a rotational rheometer the minimum melt viscosity is below 100 Pas. Preferred are powder coating compositions of the invention having a melt viscosity of below 50 Pas, particularly below 10 Pas, for example, 1 to 8 Pas.

The present invention provides a powder coating composition comprising preferably
(A) 25 to 99.9 wt % of at least one hydroxyl functional polyuretdione resin binder
(B) 0 to 75 wt % and optionally, 1 to 50 wt % of at least one resin binder and optionally at least one curing agent, different from (A), and
(C) 0.1 to 60 wt % of pigments, fillers and/or coating additives,
   the wt % amounts based on the total weight of the powder coating composition (A) to (C), wherein the at least one hydroxyl functional polyuretdione resin binder (A) having a melting temperature of 60 to 180° C., in particular, 80 to 160° C.

Particularly preferred is a powder coating composition comprising
(A) 40 to 95 wt % of at least one hydroxyl functional polyuretdione resin binder,
(B) 0 to 50 wt % and optionally, 1 to 50 wt % of at least one resin binder and optionally at least one curing agent, different from (A), and
(C) 5 to 50 wt % of pigments, fillers and/or coating additives,
   the wt % amounts based on the total weight of the powder coating composition (A) to (C), wherein the at least one hydroxyl functional polyuretdione resin binder (A) having a melting temperature of 60 to 180° C., in particular, 80 to 160° C.

The components of the present invention are mixed, extruded and ground by conventional techniques employed in the powder coatings art familiar to a person of ordinary skill in the art. Typically, all of the components of the present powder coating formulation are added to a mixing container and mixed together. The blended mixture is then melt blended, for example, in a melt extruder. The extruded composition is then cooled and broken down and ground to a powder. The ground powder is subsequently screened to achieve the desired particle size, for example, an average particle size (mean particle diameter) of 20 to 200 μm, determined by means of laser diffraction.

It is possible that a predetermined amount of a component of the powder coating components be added, for example, to the polyuretdione resin (A) and further components of the composition according to the invention, and then premixed. The premix can then be extruded, cooled, and thereafter pulverized and classified.

The composition according to the invention may also be prepared by spraying from supercritical solutions, NAD “non-aqueous dispersion” processes or ultrasonic standing wave atomization process.

Furthermore, specific components of the powder coating composition according to the invention, for example, additives, pigments, fillers, may be processed with the finished powder coating particles after extrusion and grinding by a “bonding” process using an impact fusion. For this purpose, the specific components may be mixed with the powder coating particles. During blending, the individual powder coating particles are treated to softening their surface so that the components adhere to them and are homogeneously bonded with the surface of the powder coating particles. The softening of the powder particles' surface may be done by heat treating the particles to a temperature, e.g., 40 to 100° C., dependent from the melt behavior of the powder particles. After cooling, the mixture the desired particle size of the resulted particles may be proceed by a sieving process.

The powder coating compositions of the present invention can be readily applied to metallic and non-metallic substrates. The compositions of the present invention can be used to coat metallic substrates including, but not limited to, steel, brass, aluminum, chrome, and mixtures thereof, and also to other substrates including, for example, heat-sensitive substrates, such as, substrates based on wood, plastics and paper, and other substrates based, for example, on glass and ceramics.

Depending upon the requirements placed upon the coated substrate, the surface of the substrate may be subjected to a mechanical treatment, such as, blasting followed by, in case of metal substrates, acid rinsing, or cleaning followed by chemical treatment.

The powder coating composition of this invention may be applied by, e.g., electrostatic spraying, electrostatic brushing, thermal or flame spraying, fluidized bed coating methods, flocking, tribostatic spray application and the like, also coil coating techniques, all of which are known to those skilled in the art.

Prior to applying the coating composition of the invention the substrate may be grounded but not pre-heated, so that the substrate is at an ambient temperature of about 25° C. (77° F.).

In certain applications, the substrate to be coated may be pre-heated before the application of the powder composition according to the invention, and then either heated after the application of the powder composition or not. For example, gas is commonly used for various heating steps, but other methods, e.g., microwaves, infra red (IR), near infra red (NIR) and/or ultra violet (UV) irradiation are also known. The pre-heating can be to a temperature ranging from 60 to 260° C. (338 to 500° F.) using means familiar to a person of ordinary skill in the art.

After being applied, the coating can be cured or post-cured by exposing by convective, gas and/or radiant heating, e.g., IR and/or NIR irradiation, as known in the art, to temperatures of, e.g., 100° C. to 300° C. (212 to 572° F.), preferably, 140° C. to 200° C., object temperature in each case, for, e.g., 2 to 20 minutes in case of pre-heated substrates, and, for example, 4 to 30 minutes in case of non-pre-heated substrates.

After being cured, the coated substrate is typically subjected to, for example, either air-cooling, or water quenching to lower the temperature to between, for example, 35 and 90° C. (95 and 194° F.).

The substrate is coated with an effective amount of the present powder coating composition so as to produce a dry film thickness that ranges, for example, from 10 to 300 μm, preferably 20 to 100 μm, particularly from 10 to 50 μm for very thin film coatings.

The powder coating compositions according to the invention can be applied directly on the substrate surface as a primer coating or on a layer of a primer which can be a liquid or a powder based primer. The powder coating compositions according to the invention can also be applied as a coating layer of a multilayer coating system based on liquid or powder coats, for example, as clear coat layer applied onto a color-imparting and/or special effect-imparting base coat layer or as pigmented one-layer coat applied onto a prior coating.

The present invention is further defined in the following Examples. It should be understood that these Examples are given by way of illustration only. As a result, the present invention is not limited by the illustrative examples set forth herein below, but rather is defined by the claims contained herein below.

### EXAMPLES

The term “parts” used in the description below has the meaning of parts per weight.

### Example 1

### Preparation of a Self-Crosslinking Polyuretdione Resin Binder of the Invention

In a three necked glass reactor equipped with stirrer and thermocouple 135.5 parts of 1,6-Hexanediol are filled, and heated to 70° C. till the diol is molten. Under stirring a mixture of 94.4 parts of 1,6-hexamethylenediisocyanate and 110.7 parts of Desmodur® N 3400 (commercially available from Bayer) are added dropwise over 1 hour. During addition the temperature is rising to 125° C. The reaction mixture is kept at 125° C. for additional 30 minutes till no NCO-value is detectable. The product is filled out. It solidifies at temperatures below 120° C. The end of the endothermic melting range in DSC measurement (heating rate 10K/min) was determined with 116° C.

### Example 2

### Preparation of a Powder Coating Composition of the Invention

81 parts of the resin binder of Example 1 is combined with 0.33 parts of benzoine and 0.7 parts of Resiflow® PV88. It is extruded at 100° C., milled in a lab mill, applied on a steel panel and baked for 30 minutes at 160° C. The resulting clear coat film shows a good appearance, gloss of 81 units at 20° C. angle (DIN EN ISO 2813), an Erichsen cupping (DIN EN ISO 1520) result of 7.2 mm and no cracks in conical mandrel test (DIN EN ISO 6860). The weather stability was checked according to GSB AL 631 specification. The gloss after 1000 hour UV-B test is 51%.

1. A powder coating composition comprising at least one hydroxyl functional polyuretdione resin binder, wherein the at least one hydroxyl functional polyuretdione resin binder having a melting temperature of 60 to 180° C.

2. The powder coating composition of claim 1 wherein the at least one hydroxyl functional polyuretdione resin binder having a melting temperature of 80 to 160° C.

3. The powder coating composition of claim 1 wherein the at least one hydroxyl functional polyuretdione resin binder has a hydroxyl value in the range of 20 to 300 mg KOH/g and a number-average molar mass in a range of 1000 to 5000, determined according to ISO 13885-1.

4. The powder coating composition of claim 1 wherein the at least one hydroxyl functional polyuretdione resin binder is produced by reacting NCO functional uretdiones based on aliphatic diisocyanates with linear diols.

5. The powder coating composition of claim 1 comprising
(A) 25 to 99.9 wt % of at least one hydroxyl functional polyuretdione resin binder,
(B) 0 to 75 wt % and optionally, 1 to 50 wt % of at least one resin binder and optionally at least one curing agent, different from (A), and
(C) 0.1 to 60 wt % of pigments, fillers and/or coating additives,
the wt % amounts based on the total weight of the powder coating composition (A) to (C), wherein the at least one hydroxyl functional polyuretdione resin binder (A) having a melting temperature of 60 to 180° C.

6. The powder coating composition of claim 1 comprising
(A) 40 to 95 wt % of at least one hydroxyl functional polyuretdione resin binder,
(B) 0 to 50 wt % and optionally, 1 to 50 wt % of at least one resin binder and optionally at least one curing agent, different from (A), and
(C) 5 to 50 wt % of pigments, fillers and/or coating additives,
the wt % amounts based on the total weight of the powder coating composition (A) to (C), wherein the at least one hydroxyl functional polyuretdione resin binder (A) having a melting temperature of 80 to 160° C.

7. A method for coating a substrate applying the powder coating composition according to claim 1 on the substrate and curing the applied powder coating composition.

8. A substrate coated with the powder coating composition of claim 1 and cured.
